(19) United States
(12) Patent Application Publication
(10) Pub. No.: US 2004/0024778 A1
(43) Pub. Date: Feb. 5, 2004

(54) System for indexing textual and non-textual files

(76) Inventor: Meng Soon Cheo, Singapore (SG)

Correspondence Address: Ladas & Parry, 26 West 61st Street, New York, NY, 10023, US

(21) Appl. No.: 09/961,916

(22) Filed: Sep. 24, 2001

(30) Foreign Application Priority Data
May 25, 2001 (SG) 200103138-4

(51) Int. Cl. G06F 17/00

(52) U.S. Cl. 707/104.1

(57) ABSTRACT

In a system for indexing computer files or records, a data storage device stores the computer files or records, wherein each of the computer files or records is identifiable by one or more attributes, a first collection of information including a series of the attributes, and a second collection of information including entries for each of the computer files or records that is to be indexed. Linking means then link the information with attributes and entries to identify the presence or absence of one of the attributes in each computer files or records being indexed.

### FIELD OF THE INVENTION

The present invention relates to an indexing system, and in particular, to a computer-based method and system of indexing and searching any files or records of a digital nature, whether textual or non-textual, structured or unstructured, that are stored on any computer-readable media.

### BACKGROUND AND RELATED ART

The computer is a useful tool for the storage, processing and retrieval of large amounts of data and informational materials. It is common for most users to have literally hundreds if not thousands of documents, spreadsheets and multimedia files on their local computer system, and probably networked to other computers to enable file-sharing. Furthermore, many universal resource locators (URLs) available on the Internet point to a vast number of files and information available to the computer users for use or can be downloaded.

In particular, there is now a rapidly growing volume of non-textual multimedia files. Such files make conventional indexing methods difficult to use, if can be used at all. The advent of affordable scanners and digital cameras, and the growing popularity of MP3 audio files, further fuels the need for an indexing system that can significantly simplify and speed up the process of indexing and searching of textual and non-textual computer files. In the case of personal computers (PCs), it is not uncommon now to have multiple gigabyte hard drives in them. Many of the files can belong to multiple categories of classification. Hence, the strict hierarchical files-within-folders-within-folder structure of PC systems presenting itself as a passive ineffective filing and indexing mechanism. It still requires computer users to do all the work in organizing the files, and remembering minimally the highlights if not the content of those files, the names given for those files and where they are stored.

One way to overcome this retrieval problem is to give each stored file a long descriptive name, and then provide the user with a list of file names from which to choose. One manifestation of this method is the Windows Explorer program supplied in Microsoft's Windows operating environment, which gives a tree-view of the drive's hierarchical structure and for the selected directory, a listing of all its files. Unfortunately, this method has the drawback of having the user still to remember the file's long name or highlights based on just the file name. In large systems, the number of file names may be so large, and the number of directories so many, that it is difficult and time consuming for a user to locate a desired file. Again, the user must be able to recall the name of the file and where it is being stored.

For textual documents, for example, Microsoft's Word (.doc) documents, IBM's Lotus WordPro (.lwp) files, Borland's WordPerfect (.wp) files and standard ASCII text (.txt) files, there are full text retrieval applications in use today that usually require an indexing process to index every word in the documents except specified ‘noise’ words. The indices built will have the indexed words and pointers to the locations of these words within the indexed documents. It is not surprising to find that these indices are often larger than the documents themselves. Many of these indexing processes require preparatory procedures and pre-processes to define noise words, to prepare the documents and to demarcate the sections within for proper indexing and are thus beyond the grasp and time of most laymen. When an indexed document is deleted, it would usually require an “un-indexing” process to remove all indices' pointers built for indexed words in the deleted document. Likewise, when a document's content is modified, it would also need a re-indexing process to rebuild those indices. In many cases, it involves removing the indices followed by a new indexing process, as words might have been deleted, new words added, and existing word positions shifted. This is to prevent erroneous results, like pointing to the wrong word, when being searched on and retrieved. However, most users searching for a needed document are not really concerned with every word that is in the document, but usually uses search words based on key areas or items of interest that the document covers.

With regard to non-textual files, it is indeed much more complex and difficult to index these because of their diversity and their lack of any verbose textual information. Some examples are digital images (.JPG, .GIF, etc.), digital recording of musical pieces (.MP3, .WAV, etc.), streaming images (.MPG, AVI, etc.), marketing brochures (.PDF, .TIF, etc.), presentation files (.PPT, .PRZ, etc.), spreadsheets (.XLS, .123, etc.), etc.

One common method, particularly suited for still images, is the use of thumbnails. Thumbnails are scaled down representations of the original images. A screen of thumbnails enables the user to visually scan for the required image. Such visual scan must be carried out sequentially, screen by screen and directory by directory. It can be rather time consuming, as the building of and displaying of thumbnails takes time, especially when thousands of images are involved.

For still images, there are also sophisticated methods developed to identify the color, texture, shape and location of objects in the image (e.g. QBIC—Query-By-Image-Content) and these attributes are used for subsequent matching and retrieval. Some disadvantages of these methods are that they are very CPU intensive, require a sample with the required “look-alike” content to be used as the searching template or pattern and do not always produce accurate results.

The more common indexing method in use today, especially for non-textual files, involves the manual inspection of the files, for example an image file, and manually assigning descriptive keywords as annotation to describe the content, nature, characteristics, constitution or attributes of the file. This is a manual form of content-based indexing. These descriptive keyword strings are usually stored together with the image files as annotations, often into a database or some proprietary indexing or file management system. This makes the files not easily accessible, even inaccessible except through the proprietary system that indexes and stores them. The annotation strings are usually indexed to achieve faster searching and retrieval, but unlike full-text retrieval, these indices point to the location of the files (instead of words within the file).

Keyword annotation is easy enough for most laymen. One uses keywords to describe what one sees (for images and video streams) or knows or hears (for songs or audio recordings) or read (for textual documents) or a mixture of all the above. It is as concise and as accurate as the user (the cataloguer or indexer) wants it to be. The main advantage of keyword annotation is that it usually does not require any tedious preparatory works and that keywords can be defined and indexing performed real-time.

However, it requires the repeated keying of these keywords for files that have some similar content, subjects, nature, characteristics, constitution or attributes (hereafter all simply termed as “attributes”). For example, every digital photograph of Henrietta would need to be annotated with at least the keyword “Henrietta” (or the equivalent, such as “Henrie” or “Rita”, as long as it is consistently used). It also requires the user to remember the keywords that have been used for specific attributes to ensure consistency in annotating and to ensure subsequent retrieval using the right (same) keyword. For example, using “Henrie” as a search term will not retrieve image files annotated with “Rita” or “Henrietta”.

Repeated typing means greater chance of typing errors. This means that the affected file will not be retrieved using the intended keyword (“Henrietta”) unless the same typing error (“Henritta”) is repeated (purposely or accidentally) during searching. Also, over the course of time, inconsistent use of keywords will appear (though not deliberately) usually involving synonyms (“school” or “college”), singular and plural usage (“girl” or “girls”), abbreviations (“B-Day” or “Birthday”) or abbreviated terms or slang (“bike” or “bicycle”) and others. Using ‘bike’ to search will not retrieve images annotated with “bicycle” keyword.

Often, over a period of time, it is tough for the user to remember the many keywords that have been used to annotate files and, to use it consistently. In a multi-users environment, this is further amplified as it is even more difficult for one user to determine what annotation keywords have been assigned previously by others. One resort is to guess.

Some applications attempt artificial intelligence and dictionary support methods to overcome the tenses and typographical-error problems when defining keywords—all slowing down the indexing and searching process. Other applications introduced thesaurus support, such as in U.S. Pat. Nos. 4,384,329 and 5,926,811 (although these 2 patents are intended for text-retrieval of documents). Thesaurus support introduces an expanded list of keywords for use during the search. The disadvantage is that this results in an even longer processing time and a longer expansive list of retrieved files, compounded by the ever-increasing explosion of documents and files in the system.

Another disadvantage of the keyword annotation method is that to change a keyword from “Rita” to “Henrietta”, every file previously annotated with the keyword “Rita” must be retrieved and re-annotated with “Henrietta”. If this is not done, using “Henrietta” to search will not retrieve previous images annotated with the “Rita” keyword (both names referring to the same person). The same would also apply if one decided to drop “Rita” as a search keyword—every file annotated with the keyword “Rita” must be retrieved and the keyword removed.

It should also be noted that for full-text indexing, the search criteria have to be specified using the same language of the indexed documents. For keyword annotation method, the annotated keyword can be in any language but it requires that the same keyword in that same language be used as search criteria subsequently. Hence, digital images or most non-textual files that transcend languages, are now limited to only one language by these indexing methods. A set of images, once annotated is no longer language-transparent. A Frenchman cannot use a French word of “chien” to look for “dog” images because someone had indexed those images using the keyword “dog”.

What is really needed is a single facility of indexing (and searching) of textual and non-textual files that overcome many of the above mentioned problems of the prior art while retaining the simplicity of keyword annotation method.

### SUMMARY OF THE INVENTION

It is an object of the present invention to provide a facility for users to easily index computer digital files, whether textual, non-textual, structured, unstructured, or a combination, so that the files can be indexed, searched and retrieved accurately, quickly and efficiently.

It is a further object of the present invention to provide a facility whereby a list of already defined attribute keywords can be provided to users to index and to search on without resorting to guessing or introducing new keyword of similarly meaning.

It is a further object of the present invention to provide a facility for users or cataloguers to use any languages (that can be captured and displayed onto a computer screen) to index, and allows other users to use different languages (from that used in the indexing process) to search on the same collection of computer digital files at the same period of time.

It is a related object of the present invention to overcome many of the mentioned problems of the prior art while retaining the simplicity of and improving on the keyword annotation method. Further objects and advantages of my invention will become apparent from a consideration of the drawings and ensuing description.

According to a first aspect of the invention, the invention provides a system for the indexing of computer files or records, comprising a data storage device capable of storing a plurality of computer files or records wherein each computer file or record is identifiable by one or more attributes; a first collection of information including a series of attributes of the computer files or records by which said computer files or records are identifiable; and a second collection of information including entries for each computer file or record that is being indexed; characterized in that the system comprises linking means for linking the entries in the second collection of information with specific attributes in the first collection of information to identify the presence or absence of an attribute in each computer file or record being indexed.

According to a second aspect of the invention, the invention provides a method of indexing a collection of computer files or records in a data storage device, each computer file or record being identifiable by one or more attributes, comprising the steps of maintaining a first collection of information including a series of attributes of the computer files or records by which said computer files or records are identifiable and a second collection of information including entries for each computer file or record that is being indexed; providing linking means for linking the entries in the second collection of information with specific attributes in the first collection of information to identify the presence or absence of an attribute in each computer file or record being indexed.

According to a third aspect of the invention, the invention provides a method of indexing a collection of computer files or records in a data storage device, each computer file or record being identifiable by one or more attributes, comprising the steps of maintaining a first collection of information and a second collection of information; providing an input means for a user to define, select and/or modify the description of attributes in the first collection by which the computer files or records are identifiable; providing display means for the description of attributes in the first collection such that users can view and select for use all defined attributes; providing linking means to link segments of information in the second collection, each segment of information defining the presence or absence of a defined attribute to the attributes of the first collection; wherein the second collection includes location pointers pointing to the location of the indexed computer file or record.

It will be convenient to hereinafter describe the invention in greater detail by reference to the accompanying drawings that illustrate one embodiment of the invention relating to the indexing of computer files. The particularity of the drawings and the related description is not to be understood as superseding the generality of the broad identification of the invention as defined by the claims.

### BRIEF DESCRIPTION OF THE DRAWINGS

FIG. 1a illustrates several examples of implementing the MAD detail data structure as file or files, and the relative positioning of fields within the MAD file or files.

FIG. 1b illustrates the MAD detail data structure implemented as sets within a file.

FIG. 1c illustrates the MAD detail data structure implemented as 2 individual files.

FIG. 1d illustrates the MAD detail data structure as in FIG. 1c but implemented to effect the “sub-view” capability.

FIG. 2a illustrates a novel way of using bitmap index by reversing its conventional usage.

FIG. 2b illustrates a novel way of indexing using the example in FIG. 2a but implementing the “Sequential Identifier Referencing” indexing technique.

FIG. 3 is a schematic illustration illustrating the relationships between a Master Attributes Definition (“MAD”) detail records, an Attribute Index Definition (“AID”) detail record, an Indexed Target File and the front-end display screen according to the described embodiment of the invention.

FIG. 4 is a schematic diagram illustrating the data-flow of MAD and AID-DS and their relationship during Attribute Definition, Indexing and Searching processes.

### DETAILED DESCRIPTION OF THE PREFERRED EMBODIMENT OF THE INVENTION

This section describes the structural aspects of the invention. This invention can be implemented in any device capable of executing programming codes. Some examples, and not limiting its scope, are mainframe computers, ‘Unix’ workstations and servers, PDAs and personal computers. The device can be local or remotely connected on a network. The term, “program application” refers to any device or program in which the methods and principles of this invention, whether in part or in full, are implemented. The term “target file” refers to a computer file or record that can be indexed. The term “indexed target file” refers to a target file that has been indexed by the program application. For simplicity and clarity, when describing the invention's methods and principles hereafter, a personal computer environment running the widely used Microsoft's Windows, and its hierarchical directory structure are used for the purpose of illustration, and it is not intended to limit the application of the invention.

The key aims of this invention are to provide an easy means of indexing and searching computer files and records and to overcome many of the mentioned problems of the prior art. This is achieved by avoiding the embedding or annotating of attributes or keywords' definitions into target files, indices or other associated files, and providing a novel linking means to maintain their inter-relationships. This invention fulfills this requirement by using 2 collections of data identifiers of key information, namely a Master Attributes Definition (hereafter, refer to as “MAD”) data structure and an Attribute Index Definition (hereafter, refer to as “AID”) data structure. These 2 data structures are created, populated with relevant information, and their inter-relationships maintained and synchronized by methods and techniques of this invention. In order not to have keyword definitions embedded into any files or indices, each keyword (or attribute) is assigned a unique unchangeable identifier-ID when it is first defined into the MAD data structure. It is this unique identifier-ID (instead of the actual keyword) that is captured or represented into the leaf indices built into the AID data structure for the collection of indexed target files. Each identifier-ID is thus mapped uniquely to a field within the MAD file where the description for the actual defined keyword or attribute of the identifier-ID is kept. In the preferred embodiment, the identifier-ID is assigned a sequential number whenever a new keyword attribute is defined, giving the identifier-ID its uniqueness.

MAD and AID are data structures that may be manifested independently in various forms. Such forms include database tables or rows, entries within Microsoft's Windows Registry, index entries in index structures, index entries in index records or in index files, or any equivalent file structures or file-systems in the designated operating platform (e.g. libraries on mainframes) that the program application runs on. When implemented as files, both the MAD and AID data structures can be implemented as one or more files. That is to say, the whole data structure can be implemented as one file, or each field within the data structure can be implemented as distinct files. The MAD and AID data structures set out hereafter are termed MAD and AID file-set respectively in their implementation as one or more files. The physical manifestation of MAD and AID data structures is a matter of the program application's design and implementation. This invention is not dependent on the location or on the types of physical implementation of the MAD and AID data structures, but on the maintenance of the inter-relationships of these data fields in the MAD and AID data structures to achieve the linking means through a novel indexing technique.

The Master Attribute Definition (MAD) Data Structure Set

The MAD data structure consists of one header set of control information fields and one or more detail sets of information fields. There is one detail set for one defined attribute for the designated category. A user could use just one MAD file-set to maintain all known classifications and categories of objects and studies as one major designated category, for example, “All Fishes”. The user could also use one MAD file-set for “Marine Fishes” category and another MAD file-set for “Freshwater Fishes” category. Alternatively, the user could sub-categorize “Marine Fishes” into “Oceanic Fishes” category and “Marine Aquarium Fishes” category, and sub-categorize “Freshwater Fishes” into “Tropical Fishes” and “Cold-water Fishes” categories, resulting in four MAD file-sets being used to capture attributes for four designated categories. This provides simplicity and better classification as each MAD file-set carry only defined attributes relevant to its designated category.

A) MAD Header Set (MAD-HS) Information.

The MAD header data structure (hereafter, refer to as MAD-HS) maintains the control information for the designated category. The MAD-HS as defined using Microsoft's Visual Basic as example for one form of definition, is as below:

Public Type madHeader

MADH_AttrCnt As Long

MADH_MaxAttrCnt As Long

End Type

a) MADH_AttrCnt.

This field contains the latest number of active attributes defined and captured in this MAD file-set for the designated category, excluding deleted attributes. The value in this field is incremented by 1 whenever a new attribute is defined and added into MAD-DS for the designated category. Likewise, when an attribute is deleted or removed from the designated category, the value is decrement by one.

b) MADH_MaxAttrCnt.

This field contains the cumulative total number of attributes defined for the designated category, including deleted attributes. The value in this field is incremented by 1 whenever a new attribute is defined and captured into MAD-DS for the designated category.

It is possible for some implementations to derive the values of MADH_AttrCnt and MADH_MaxAttrCnt from the MADD_AttrDesc array and thus these 2 fields in MAD-HS may not be necessary. Optionally, an additional field of “MADH_CatName As String” could be introduced into MAD-HS (among other optional fields) to capture the name for the designated category provided by the user during the creation of this MAD file. It is primarily used for display purposes by the program application to denote the current session's designated category or subject matter. Alternatively, it can be used to designate or construct the filenames for the MAD file-set and all associated AID file-sets.

B) MAD Data Structure (MAD-DS) Detail Information.

The MAD details data structure (hereafter, refer to as “MAD-DS”) maintains information relating to each and every defined active attribute for the designated category. The MAD-DS for one designated category, as defined using Microsoft's Visual Basic as example for one form of definition, is as below:

Public Type madDetail

MADD_AttrDesc( ) As String

MADD_PosSeqNbr( ) As Long

End Type

a) MADD_AttrDesc.

This is an array with each field containing the description for each defined attribute as provided by the user. The description can be a word, a phrase, a sentence or sentences. This is where the description of each attribute is defined once and once only and stored. This description is not annotated into other records or files, or embedded into any indices. It is used to build the list of defined attributes and displayed to user during new attribute definition, indexing and searching operations. This relieves the user of remembering or guessing what keywords have been defined previously by the user or by other users.

b) MADD_PosSeqNbr.

This is an array with each field containing the assigned sequence number for its corresponding defined attribute MADD_AttrDesc when it was first defined. Every new attribute defined will have one and only one sequential number uniquely assigned (also refer to as the Identifier-ID). This sequence number, once allocated, is fixed and cannot be changed or reassigned even if the attribute is deleted. Hence, MADH_MaxAttrCnt contains the last sequence number assigned. This field can be optional if 1) new attribute description is assigned for storage into the array in a sequential manner and 2) deleted attribute exists as blank description (or any pre-determined value) and are not removed from the MADD_AttrDesc array (and AID file-sets). That being the case, the occurrence number, that is the field position of the attribute description field within the MADD_AttrDesc array can be used in place of MADD_PosSeqNbr. However, for this detailed discussion of the invention, MADD_PosSeqNbr is used to track the Identifier-ID's sequence number in order not to be limited by the above two implementation points for the preferred embodiment.

Optionally, an additional field of “MADD_RefLoc As Long” could be introduced (among other optional fields) into MAD-DS to store the location value, whether absolute or relative, of the physical manifestation of the defined attribute on the display front-end (or onto a report). The physical manifestation of each attribute can be represented by a checkbox, a radio button, or any equivalent objects that can contain the attribute's description and indicate its two-state status for display on the front-end screen (or on a printed report). This additional field is not a mandatory field to implement the invention, though useful in many instances, as display positions are usually hard-coded, or pre-determined, or controlled by the program application. However, with this additional field, the program application using this invention can eliminate the hard-coding of locating and positioning the physical manifestation of the defined attribute and is able to handle multiple locations for the attribute's object on multiple screen, file and report layouts.

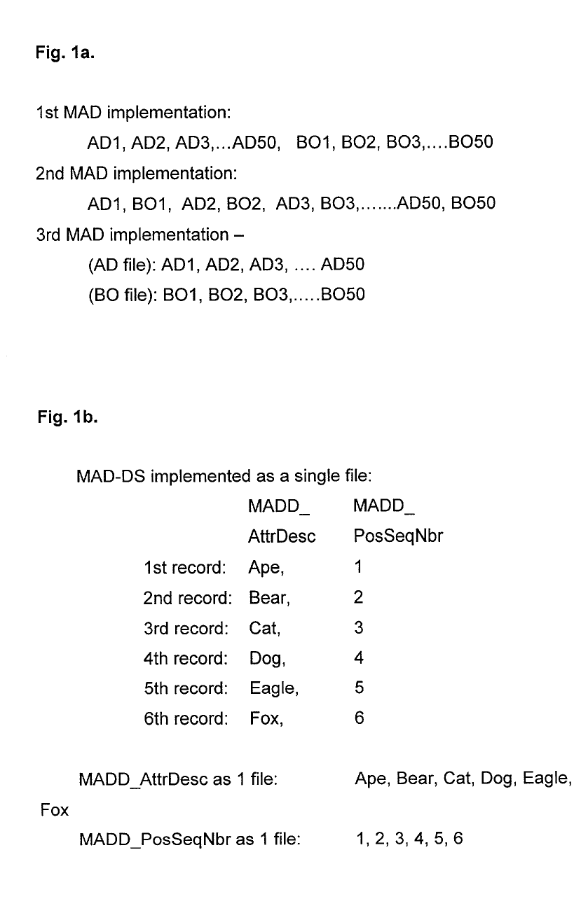

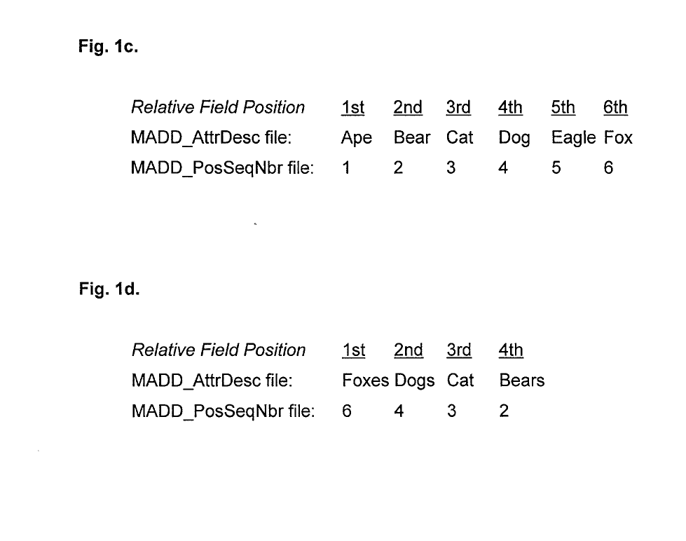

The above two sets of information (three if we include MADD_RefLoc) are closely related to one another—in that their relative physical positions and order within their respective sets or files are maintained at all times with each other. Each piece of information for a defined attribute within one set or file has its other associated piece of information correspondingly positioned in the other set or file. This is illustrated in Figure la, showing a few variations of MAD-DS implementation as one or more files for a designated category of “Animals”. In all cases, the position of a MADD_PosSeqNbr field corresponds to its associated MADD_AttrDesc field in a relative manner within their respective sets or files. The first implementation shows MADD_AttrDesc data identifier existing as a contiguous series of fields, followed by MADD_PosSeqNbr data identifier as the next contiguous series of fields, with AD1, AD2, AD3, etc., corresponding to their respective BO1, BO2, BO3, etc. The second implementation shows MADD_AttrDesc data identifier and MADD_PosSeqNbr data identifier existing as a contiguous series of paired fields. FIG. 1b is one example of this implementation but in multiple records, each paired field in 1 record. The third implementation shows MADD_AttrDesc data identifier existing as a contiguous series of fields in its own file and MADD_PosSeqNbr data identifier existing as a contiguous series of fields in its own file. The relative position of each MADD_AttrDesc field corresponds to the relative position of its respective MADD_PosSeqNbr fields. FIG. 1c is one example of this implementation.

For MAD implemented as a single file, one representation is illustrated in Figure lb. The MAD-HS is the first record with the file (not illustrated). Each subsequent detail record has the two fields of MAD-DS (excluding the optional MADD_RefLoc). The first field is the MADD_AttrDesc entry and the second field is the MADD_PosSeqNbr entry. The order of layout for the two fields is immaterial as long as the two MAD-DS fields are consistently represented and understood by the program application.

When the 2 MAD-DS detail fields are each implemented as separate files, the attribute's definition values within each record of the two separate files are as illustrated in FIG. 1c. MADD_AttrDesc is a onerecord file having six consecutive fields and values: Ape, Bear, Cat, Dog, Eagle and Fox. Likewise, MADD_PosSeqNbr is also a one-record file having six consecutive fields and values: 1, 2, 3, 4, 5 and 6. Each corresponding field within the two files contains related information for one defined attribute. (Alternatively, instead of a single-record file of 6 entries, each of the entry can exist as a single record, making the file now having 6 single-entry records). In this implementation, the two MAD-HS fields, MADH_AttrCnt and MADH_MaxAttrCnt, can exist as header records for the MADD_AttrDesc and MADD_PosSeqNbr files respectively.

If there is a requirement to provide attribute descriptions in multiple languages, for example Spanish, then a new MADD_AttrDescr file content, translated from the master version of the MAD_AttrDesc file of FIG. 1c, would be set out as follow—MADD_AttrDescr-Sp file: Simio, Oso, Gato, Perro, Aguila, Zorro (Spanish for: Ape, Bear, Cat, Dog, Eagle, Fox). With this capability, users can now indicates their language of choice to use for indexing and searching of target files by selecting the appropriate translated version of MAD_AttrDesc files, even though the initial definition of these attributes' descriptions were specified in a different language. The program application utilizing this invention will use the selected MAD_AttrDesc file to display the full list of attributes in the selected language for the user to use. Thus it is possible that different users use different languages to index the same collection for files at the same time (though not on the same file, as it should be locked by the program application to prevent integrity problem). Likewise, the searching can be in any translated languages available. This significant feature is missing from most prior art. It is recommended though not a real necessity, that the initial definition of new attribute keyword or description be in one specific language upon which other translations are derived.

If there is a requirement to restrict usage of keywords or attributes, it is also possible to create sub-sets from the master MAD file-set to provide the sub-view capability (e.g., for security reasons, restricting indexing or searching operations to a sub-set of keywords). For example, using the MAD-DS detail files in FIG. 1c, a sub-set for just four attributes could be supplied as shown in FIG. 1d. For sub-view MAD file-set, MADH_AttrCnt field contains the actual number of attributes captured in the sub-view MAD file-set. In the FIG. Id example, the descriptions have been changed to their plural forms. However, this change will not impact all previously indexed target files. This is because the attributes still retain the same MADD_PosSeqNbr Identifier-ID's values (and should not be changed for defined attributes). The values in MADD_PosSeqNbr are referenced within the AID detail sets. The removed MADD_PosSeqNbr of the sub-view might still exist in AID detail sets (within AIDD_PosSeqNbr) that has been indexed using the “full-view” MAD file-set. However, during indexing or searching using the sub-view MAD file-set, the AIDD_PosSeqNbr would not find a match against the “sub-viewed” MAD file-set as the MADD_PosSeqNbr has been removed in the sub-view. Again, a useful feature not readily implementable or available in many of the prior art.

It is recommended that there should be one complete Master MAD data structure set, whether implemented as a set within a file or each field as individual file. All new attributes are first defined into it. All modifications are first carried out on it. All language translations and all sub-view MAD file-set (or files) are derived from it. This would avoid possible integrity problems and corruption that could be introduced due to multiple sources of attribute definition creation or modification.

The Attribute Index Definition (AID) Data Structure

The AID data structure consists of a plurality of detail sets, one detail set of information for each occurrence of an indexed target file.

The AID data structure can have optional header information as required by the program implementation. For example, it could have an AIDH_MADPathName field containing the location (pathname) and filename of its parent MAD file-set for the designated category. This information can be used by the program application to locate, validate and access the parent MAD file-set and retrieve pertinent information such as the descriptions of defined attributes to build the front-end display screen. Optionally, the header can also include an additional counter field to register the number of target files indexed in the AID file-set.

AID Data Structure (AID-DS) Detail Information

The AID data structure (hereafter referred to as “AID-DS”) maintains information relating to each and every indexed target file on the target directory or sub-directory for the designated category. Hence, there is a plurality of AID-DS implemented as records within the AID file-set. Each detail record within the AID-DS file-set maintains indexing information for one indexed target file. The AID-DS as defined using Microsoft's Visual Basic as example for one form of definition, is as below:

Public Type aidDetail

AIDD_FileName As String

AIDD_MaxAttrCntAs Long

AIDD_IDXtoken As String

End Type

a) AIDD_FileName.

This field contains the filename (or the location pointer) of the indexed target file. Optionally, the pathname can be included (when the AID file-set does not reside on the same directory as the collection of target files it indexes).

b) AIDD_MaxAttrCnt.

This field contains the cumulative total number of attributes defined for the designated category, including deleted attributes (which in effect is also the last assigned sequence number) at the point in time when the target file is indexed or re-indexed. However, its value might differ from that in the MADH_MaxAttrCnt field as new attributes are defined and added (and hence new sequence number allocated) to the MAD file-set over time but have not been updated into all previously indexed AIDD_IDXtoken entries. Hence, this field can be used to highlight (perhaps in different color) new attributes that has been defined since the current target file was last indexed, which would enable the user to review whether the new attributes are applicable for the current target file under review. Again, one feature not readily implement-able or available in the prior art.

c) AIDD_IDXtoken.

This field contains the designated category's physical Index Structure (hereafter refers to as “IDX token”). It can be embodied in two structural forms:

1) as a collection of fields, assigned for each target file indexed, as defined using Microsoft's Visual Basic as example for one form of definition, is as below:

Public Type idxToken

AIDD_lndexCnt As Long

AIDD_PosSeqNbr( ) As Long

End Type

AIDD_lndexCnt maintains the number of attributes that have been indexed for the target file. AIDD_PosSeqNbr is an array, the number of occurrences is dictated by the value in AIDD_IndexCnt in order for each AIDD_PosSeqNbr field to capture the MADD_PosSeqNbr Identifier-ID's value of each indexed attribute for the target file. This method shall be referred to as “Sequential Identifier Referencing” [“SIR”] indexing method. It is suitable for cases where the average number of indexed attributes per target file is small (eg less than a ratio of 1 to 8) small compared to the total number of defined attributes. In this embodiment, AIDD_MaxAttrCnt is not a mandatory field within AID-DS, but could serve as a tool to highlight new attributes added after the current file was last indexed.

2) as a bitmapped index (hereafter refer to as “BIT token”) in the form of a binary string, assigned for each target file indexed. Each BIT token represents all attributes defined, including deleted attributes, for the designated category at the point in time when the target file was last indexed. Each bit within the BIT token is mapped to one defined attribute's MADD_AttrDesc (where the description for the defined attribute is kept), as indicated by its corresponding MADD_PosSeqNbr field. As the value in MADD_PosSeqNbr is sequentially assigned, it effectively assigns each bit position sequentially to each new attribute definition correspondingly. A ‘1’ state for a particular bit means the target file has been indexed for the associated attribute for that bit. A ‘0’ state means the target file has not been indexed for the associated attribute. The size of the BIT token is determined by the value in AIDD_MaxAttrCnt (and rounded up to byte boundary). For example, assuming that MAD-DS fields are implemented as individual files, and if the 3rd record within MADD_PosSeqNbr file contains a value of “4”, this would mean that the fourth bit within the BIT token will indicate the presence or absence of the attribute. The description for that attribute is in the 3rd record of MADD_AttrDesc file-set (corresponding to the 3rd record within MADD_PosSeqNbr file-set). This method shall be referred to as “BIT token” indexing method. It is suitable for cases where the average number of indexed attributes per target file is large (eg more than a ratio of 1-8) when compared to the total number of defined attributes.

3) Once an attribute is assigned to a target file, the target file is considered indexed and will have an AID-DS detail record. Of course, it can have more than one attribute assigned. When AIDD_lndexCnt is zero (for ‘SIR’ method) or all bits within the BIT token is set to ‘0’ (for the ‘BIT token’ method), the target file is considered to be un-indexed, and the AID-DS record can be removed from the AID file-set. However, the target file remain intact (i.e. is not deleted) in the directory.

MAD File-Set and AID File-Set Relationship

One MAD-DS file-set can have zero to any number of AID file-sets. When no AID file-set exist for a MAD-DS file-set, it means that no target file has yet to be indexed for the designated category. Once a target file is indexed, an AID file-set will be created to capture and maintain the indexed attributes for its collection of target files under the designated category. The number of AID file-sets to one MAD file-set is dependent of program application's design and implementation and is not limited by this invention. A program application may use one huge AID file-set (e.g., implemented as a database table) to capture and maintain all indexed attributes for all the target files indexed in all directories. In this case, the pathname of the indexed target file need to be stored into AIDD_FileName. Or the program application could be designed such that one AID file-set shall exist at each target location, example, a directory or sub-directory, to maintain indices for its collection of files in that target location (as in this described embodiment). This would mean that one MAD file-set (analogous to the top-most level index of a B-Tree index structure) could have many AID file-sets set (analogous to the bottom-most leaf index of a B-Tree index structure) spread across various target locations or directories.

When the two MAD-DS detail fields are each implemented as separate files within the MAD file-set, one method is to use the given designated category name (e.g. “Fishes”) to suffixes each filename appropriately, e.g. as “Fishes_AD.MAD” and “Fishes_PS.MAD” (for MADD_AftrDesc and MADD_PosSeqNbr respectively). Their member AID file-sets can adopt the designated category name—“Fishes.AID” in their respective directories. The program application can derive the AID file-set name from the MAD file-set name (and vice versa) and use it to search and locate the AID file-sets within the directory structure during a search process. Another method is to capture all the pathnames and filenames of all MAD-DS file-sets and all its associated AID file-sets in a cross-reference list or into relational database tables, instead of using suffixes and keeping pointers to parent MAD file-set in AID header entry.

Managing Changes Over Time

This invention does not require that all attributes must be defined beforehand before indexing can commence. This invention, because of the novel indexing structures and techniques, is able to handle these dynamic changes transparently without impact to any previously created AID file-sets and indexed target files. It allows real-time definition of new attributes into existing MAD file-set for the designated category whenever the need arises. Likewise, unwanted definitions can also be removed anytime out of the designated category. There is simply no necessity to perform massive updates operation to re-index all target files and their AID file-sets whenever changes occur. In fact, for this invention, additions, modifications, and deletions of an attribute's definition take effect immediately. Additions of new attributes have no impact as they are not captured in any existing AID file-sets. Additions and modifications of attributes' definition are applied to the central source of information namely the MAD file-set, and are thus immediately reflected in displayed list. Deletions of attribute is simply a removal of both the MADD_AttrDesc and MADD_PosSeqNbr fields, or are initialized to null or zero values (as a means of indicating deleted attribute). This would mean that existing AID file-sets may have its AIDD_PosSeqNbr field containing the deleted attribute's Identifier-ID which will not find a matching value in all MADD_PosSeqNbr fields (for ‘SIR’ indexing method). For the ‘BIT token’ indexing method, BIT tokens containing bit positional references will point to blank (or null) description in MADD_AttrDesc field.

It is very possible that over time, the values in AIDD_MaxAttrCnt will be different than in MADH_MaxAttrCnt due to addition and/or deletion of attribute definitions to the MAD file-set. Whenever the indexed target file is accessed or re-indexed, the value in AIDD_MaxAttrCnt should be updated to the latest value in MADH_MaxAttrCnt. At this point in time, the current indexed target file is up-to-date and in sync again with the latest MAD-DS definition. The values in AIDD_MaxAttrCnt and MADH_MaxAttrCnt allows the program application to detect new attribute(s) definition added to the MAD file-set since the current target file was last indexed or re-indexed. Any attribute definition with a MADD_PosSeqNbr value greater than the value in AIDD_MaxAttrCnt is a new attribute as the attribute's assigned sequence number is outside the maximum captured by AIDD_MaxAttrCnt for the current indexed target file. The program application can highlight these new attributes (in a different color) when such conditions are encountered, and can also prompt the user to review and ascertain if the new attribute(s) is appropriate for the current indexed target file. AIDD_MazAttrCnt can also be placed in the optional AID-DS's header to highlight addition of new attributes at the AID-DS file level rather than for every indexed target files in the AID-DS file.

Where BIT token is implemented, the value in the AIDD_MaxAttrCnt field can be synchronised and updated to that in MADH MaxAttrCnt whenever the target file is being accessed or re-indexed, beside using it to resize the BIT token size while retaining all its bit statuses. The value in MADH_MaxAttrCnt effectively determines the size of the physical BIT token to store all defined attributes' state in its bits for the designated category. The AIDD_MaxAttrCnt field effectively captures the number of bits assigned out of its physical BIT token for the number of attributes defined and captured at the point in time that the current target file is indexed or re-indexed. The value in AIDD_MaxAttrCnt is also used to ensure that processing the bits of the physical BIT token (AIDD_IDXtoken) for the indexed target file is within the boundary of the token size.

Detailed Operational Aspects

This section describes the operational aspect of the invention for one embodiment. For simplicity and clarity, when describing the invention's methods and principles hereafter, a personal computer environment running the widely used Microsoft's Windows, and its hierarchical directory structure are used for the purpose of illustration only, and it is not intended to limit the application of the invention.

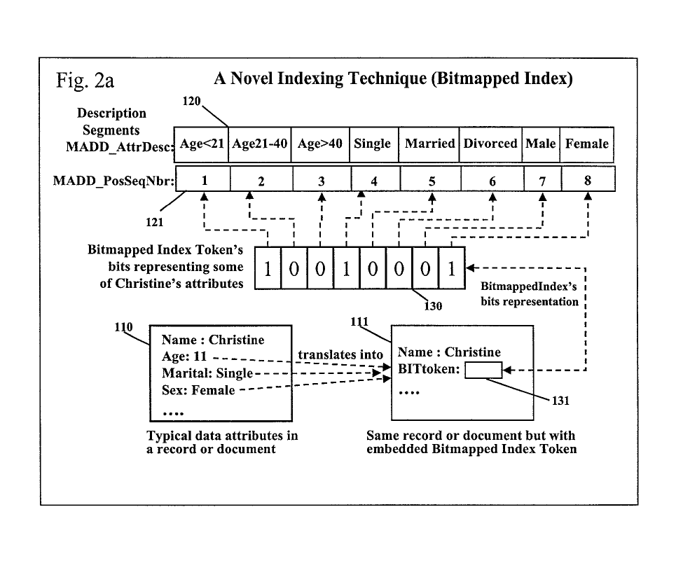

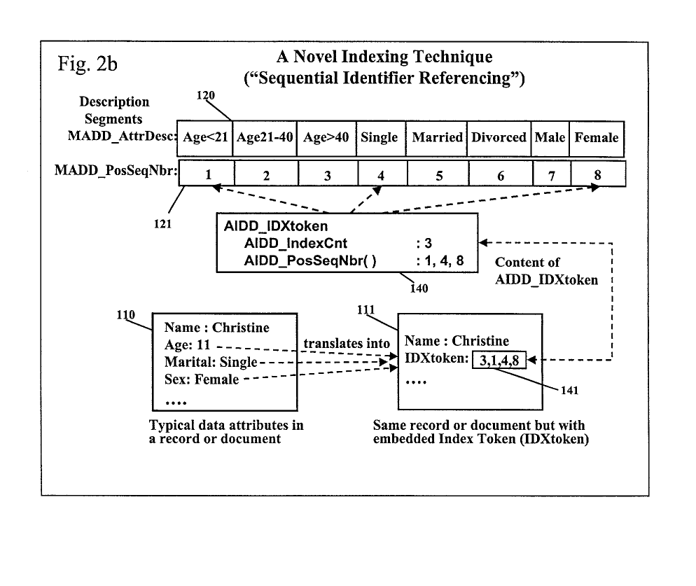

FIG. 2a is a schematic illustration according to the preferred embodiment of this indexing technique using the BIT token implementation, whereby a bitmap index is used in a novel way by reversing its conventional usage of only representing one cardinal value or attribute (e.g., “Female Gender”). Instead, it is make to represent all attributes for one given category. Bitmap indices are preferred for its efficient storage and its affinity to computer operations, being represented and executed on at binary bit level. For example, item 110 in FIG. 2 is a typical record, file or document containing certain attributes, such as age, marital status and gender. Item 120 is a file (corresponding to the MADD_AttrDesc file) containing segments with various classification values for age, marital and gender—such as age group less than 21, between 21 to 40, and greater than 40, marital status class of single, marital, and divorced, and gender group for male and female. These eight segments are each uniquely assigned a sequence number as represented by item 121 (corresponding to MADD_PosSeqNbr). These eight classifications are represented by a bitmap index as item 130, each bit within the bitmap index corresponds to 1 defined classification segment correspondingly in item 120 and item 121. Hence, for item 110 representing one particular instance of a student record or document for a single female named Christine of 11 years of age, the bit setting within the bitmap index is illustrated as item 130. A state of ‘1’ for a bit indicates the presence of that classification for the indexed target file, item 110. This bitmap index can be implemented as an embedded token, as item 131, into item 110 to replace the attributes of age, marital status and gender in item 110, now referenced as item 111.

FIG. 2b is a schematic illustration according to the preferred embodiment of this indexing technique, but using the “Sequential Identifier Referencing” implementation, whereby the unique Identifier-ID sequence number of indexed attributes for the student record are captured and stored into AIDD_IDXtoken entries. Using the same example of FIG. 2a, instead of the BIT token with its “turn-on” bits to represent corresponding indexed segments of the classification, we now have AIDD_lndexCnt with a value of 3 to denote that three classification segments have been indexed for the student record, and three occurrences of AIDD_PosSeqNbr allocated. Each AIDD_PosSeqNbr entry contains the sequence number of the indexed attributes (from MADD_PosSeqNbr), that is, the number 1, 4 and 8.

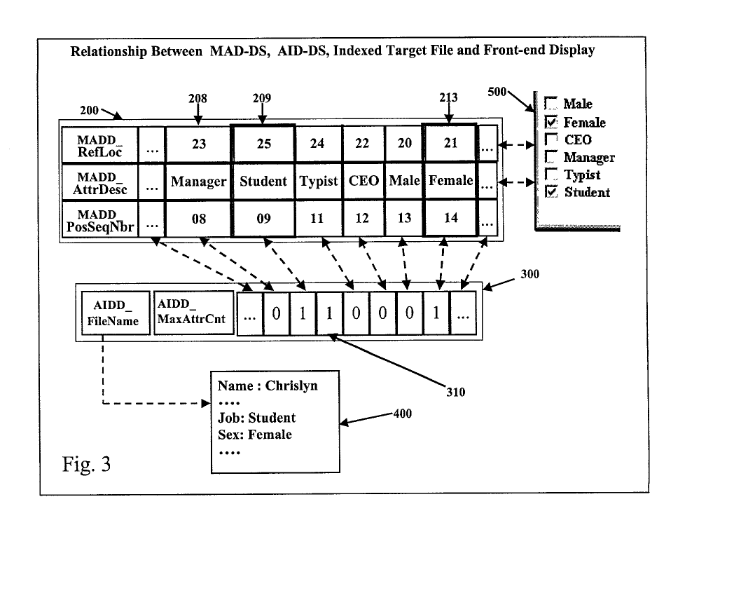

FIG. 3 is a schematic diagram illustrating the relationship between the MAD-DS detail record set, one particular AID-DS detail record, an indexed target file and the front-end display screen, according to the preferred embodiment of the invention.

Item 200 is a MAD file-set consisting of a header record (not shown) and a plurality of detail records (as shown). Each detail record (as represented by item 208, 209 and 213) consists of three pieces of information pertaining to MADD_RefLoc, MADD_AttrDesc and MADD_PosSeqNbr for one defined attribute. The inclusion of MADD_RefLoc field in this discussion is to demonstrate as one example of the capability of this invention to allow assignment of additional properties to all defined attributes as each can be individually referenced. In this case, each MADD_RefLoc entry stores the displayed position of one manifested attribute on the front-end display for indexing and searching. Each MADD_AttrDesc entry stores the description for one manifested attribute to take on as its caption. Each MADD_PosSeqNbr entry stores the sequence number of the defined attribute, which in effect, is also the position of the bit within the BIT token whose state will determine the attribute's presence or absence of that attribute for an indexed target file.

Item 300 illustrates one particular instance of a detail record in an AID file-set containing sets of AIDD_FileName, AIDD_MaxAttrCnt and AIDD_IDXtoken information. The AID file-set 300 is associated to the MAD file-set 200. The AIDD_FileName entry stores the filename of the indexed target file. The AIDD_IDXtoken entry stores the physical manifestation of the BIT token. The AIDD_MaxAttrCnt entry stores the number of bits assigned out of the BIT token at the point in time the target file was indexed.

Item 400 can be any computer digital file, whether textual, non-textual, structured, unstructured or a combination, stored on any computer-readable media. In this discussion, an employee's employment history textual document is used as example. Item 500 is a video display unit to present visually the display form(s) of the program application.

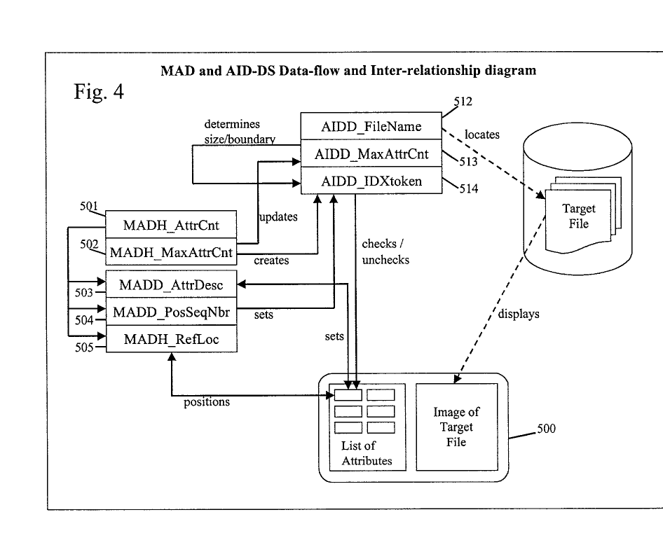

FIG. 4 is a schematic diagram illustrating the data-flow and their relationship during the processes and operations to be described below, and shall be used in conjunction with FIG. 3 when needed.

Program Application Initiation

The user selects and initiates the program application to begin its execution. Program application initializes its operating environment, builds and then displays the Main Menu form out to screen display 500. For simplicity this Main Menu form shall deem to have menu bars and command buttons to allow user to choose the various modes of operations described below. It also has a “Drives-Directories-Folders” tree-view listbox, similar to Microsoft's Windows Explorer program, as well as a file-listbox where filtered filenames within the selected directory are listed. From the Drives-Directories-Folders tree-view listbox and file-listbox, the user selects the desired MAD file-set that designates the category the subsequent indexing operations will be indexed under. In this example, it is an “Employment” category for a collection of employment record documents.

0800—New Aftributes Definition Operation

The user can define in advance known attributes for a newly designated category. (Additional attribute definitions can be added at a latter stage when the need arises.) The program application displays a blank form with a pre-determined number of blank textboxes at their pre-determined display locations. The user enters the keywords or descriptions for known attributes into the textboxes. Once done with, the program application counts the number of non-blank textboxes and put this value into MADH_AttrCnt 501 entry and MADH_MaxAttrCnt 502 entry and writes out the MAD-HS header record. It then steps through each textbox, and where it is not blank, captures its display location into MADD_RefLoc 505, copies the content of the textbox into MADD_AttrDesc 503 and assigns incrementally the next sequence number for this new attribute, starting from a value of 1, and putting this value into MADD_PosSeqNbr 504. These three pieces of information are written out as one MAD-DS detail record, one detail record for one defined attribute (that is, one non-blank textbox). At the end of this operation, a MAD file-set is created, containing the three pieces of information for all defined attributes for the designated category.

0900—Adding or Modifying Attributes Definition Operation

The program application reads in the MAD file-set header and details information and populates the textboxes with descriptions from MADD_AttrDesc 503 whose locations correspond to that in MADD RefLoc 505. All information read in from the MAD file-set are stored into their respective memory arrays or areas for subsequent processing and references. Every non-blank textbox will have its corresponding MADD_PosSeqNbr 504 value greater than zero. All blank textboxes will have its MADD_PosSeqNbr 504 value set to zero. The user can enter the keywords or descriptions for new attributes into blank textboxes. The user can modify the descriptions for existing attributes in textboxes with new keywords. The user can blank-out the descriptions for existing attributes thus turning the textboxes blank. When a textbox become blank, its corresponding MADD_PosSeqNbr 504 value is set to zero (replacing its previously assigned bit position in memory). Once done with, the program application counts the number of non-blank textboxes and put this number into MADH_AttrCnt 501. A temporary memory area temp_NextBitPosn is assigned to the value in MADH_MaxAttrCnt 502 plus 1. It counts the number of non-blank textboxes whose MADD_PosSeqNbr 504 value is zero (that is, new attribute definitions that need a bit position assigned) and add this value to MADH_MaxAttrCnt 502. It writes out the MAD-HS header record. It steps through each textbox, and where it is not blank, captures its display location into MADD_RefLoc 505, copies the content of the textbox into MADD_AttrDesc 504. Where its corresponding MADD_PosSeqNbr 504 value is zero, it assigns the next sequence number for this new attribute, starting with the value in temp_NextBitPosn, and putting this value into MADD_PosSeqNbr 504. The value in temp_NextBitPosn is next incremented by 1. These three pieces of detail information are written out as one MAD-DS detail record, one detail record for one defined attribute (that is, one non-blank textbox). At the end of this, the MAD file-set is updated to contain new and updated information for all defined attributes for the designated category.

1000—Building the Front-end Display Screen Process

Before any indexing operation or searching operation can be performed, a full list of defined attribute keywords is to be displayed onto the front-end screen 500 for user to select. The program application first read in the MAD file-set's header record to determine the number of attributes defined for the designated category. The number is stored in MADH_AttrCnt 501. Based on this number, it loads the same number of unchecked checkboxes onto the front-end display form. This form is then displayed onto the screen 500. The program application then reads each and every MAD detail record. For the first detail record read, it positions the first checkbox according to the value in the detail record's MADD_RefLoc 505 entry. It then sets the caption of the checkbox to the description stored in MADD_AttrDesc 503 entry. These two operations are repeated until every MAD detail record has been read and every defined attribute displayed. For example, referring to FIG. 3, when the 8th detail record is read in, as identified by item 208, the program application positions the respective checkbox to a relative display position of 23 on the display form as indicated by MADD_RefLoc and sets the said checkbox's caption to “Manager” as stored in MADD_AftrDesc. When the 13th detail record is read in, as identified by item 213, the program application positions the respective checkbox to a relative display position of 21 on the display form and sets the said checkbox's caption to “Female”. All information read in from the MAD file-set are stored into their respective memory arrays or areas for subsequent processing and references.

1100—Indexing an Unindexed Target File Operation

The program application locates and opens the AID file-set for the designated category on the selected directory. If no AID file-set exists in the directory, it means that the said directory has not been indexed before for the designated category. In this instance, no AID file-set exists. The program application then gets the filename of the first filtered filenames from the selected directory in the file-listbox (using a function call or an API call to Windows)—the filename obtained is “Chrislyn.doc”. The program application allocates a physical BIT token of the size determined by MADH_MaxAttrCnt 502 aligned on a word boundary and all bits set to ‘0’ states. The program application initiates a viewer program to locate, retrieve and display the document content on another window onto display screen 500. The user views the document and then clicks on the appropriate checkboxes to index the document file. In this example and referring to FIG. 3, checkboxes with descriptions of “Student” and “Female” are clicked (along with other appropriate checkboxes not shown). Responding to the click event on checkbox at relative position 21 (the “Female” checkbox), the program application locates its MAD-DS entry, that is item 213 to obtain its assigned sequence number, which also correspond to the bit position with the BIT Token, which in this case is 14. The program application sets bit at position 14 of the BIT token to a ‘1’ state. Likewise, responding to the click event on checkbox at relative position 25 (the “Student” checkbox), the Indexing locates its MAD-DS entry, that is item 209 to obtain its assigned bit position, which in this case is 9. The program application sets bit at position 9 of the BIT token to a ‘1’ state. This is repeated for all clicked checkboxes. (If a checkbox has been checked “on” before, that is its bit has been set to a ‘1’ state, the next click event will uncheck the checkbox status and the bit will be set to a ‘0’ state). If at any time a new attribute needs to be added for the designated category, the operation of “0900—Adding or Modifying Attributes Definition” can be initiated immediately. The program application then builds the AID-DS record image to be written out later by filling in the filename of the indexed target file into AIDD_FileName 512, putting the value in MADD_MaxAttrCnt 502 into AIDD_MaxAttrCnt 513, and copying the BIT token into AIDD_IDXtoken 514. The program application next gets the filename of the next document file on the selected directory, sets all bits in the physical BIT token to ‘0’ states, sets all checkboxes to “unchecked” status. This process is repeated until all files on the selected directory have been indexed, or the indexing operation stopped.

Using FIG. 3 for the case where “Sequential Identifier Referencing” indexing method is used instead of ‘BIT token’ method, the value of AIDD_IndexCnt will be 2 (for the 2 indexed checkbox's attributes) and each of the three AIDD_PosSeqNbr's values will be 9 and 14 (instead of bit positions value within the BIT token).

1200—Indexing a previously Indexed Target File Operation

The program application locates and opens the AID file-set for the designated category on the selected directory. In this instance, the AID file-set exists. The program application gets in the filename of the first document file on the selected directory—the filename obtained is “Chrislyn.doc”. The program application then opens the AID file-set and reads each AID-DS detail record until a match for “Chrislyn.doc” is found in the AIDD_FileName 512 entry. (If no match is found, it means that the document has been deleted and the next AID-DS record will be read in. If a new document is found, then “1100 - Indexing an Unindexed Target File” operation will be initiated). Stepping through each and every MADDS entry, the program application uses the BIT token of AIDD_IDXtoken 514 to set the “checked/unchecked” status of the checkboxes for the displayed list of attributes. For example, and referring to FIG. 3, when it reached the 9th entry in the MAD file-set (or memory array), that is item 209, it would use MADD_PosSeqNbr value of 9 to check the state of the bit in position 9 in the BIT token of AIDD_IDXtoken. If the state of the bit is a ‘1’, the checkbox at relative display position 25 (the “Student” checkbox) on the display form is “checked”, else it is set to “unchecked” status. (For the ‘SIR’ indexing method, instead of checking the state of bits, MADD_PosSeqNbr is checked against AIDD_PosSeqNbr to find a match). It is also worthwhile to note here that none of the MADD_PosSeqNbr values reference the bit position of item 310 in the BIT token of AIDD_IDXtoken. This means that the bit position of item 310 has been assigned previously to an attribute description that has since been deleted.

The program application initiates a viewer program to locate, retrieve and display the document content on another window onto display screen 500. The user views the document and then clicks on appropriate checkboxes to modify or update the attributes indexed for the document file. The rest of the operation is the same as in “1100—Indexing an Unindexed Target File” operation after the juncture where the user has viewed and clicked on appropriate checkboxes.

2000—SEARCH Operation

The user selects the MAD file-set to search for files indexed under the designated category. The program application first executes “1000—Building the Front-end Display Screen” to display the full list of available attribute keywords that can be used as search criteria. The user views the keyword list and then clicks on the appropriate checkboxes to set as search criteria, in this example, and referring to FIG. 3, checkboxes with descriptions of “Student” and “Female” are clicked. Responding to the click event on checkbox at relative position 21 (the “Female” checkbox), the program application locates its MAD-DS entry, that is item 213 to obtain its assigned bit position, which in this case is 14. Likewise, responding to the click event on checkbox at relative position 25 (the “Student” checkbox), the program application locates its MAD-DS entry, that is item 209 to obtain its assigned bit position, which in this case is 9. The program application saves these two bit position values for later references. For the ‘SIR’ indexing method, the equivalent of the assigned bit position is in MADD_PosSeqNbr. Likewise, these MADD_PosSeqNbr values are saved for later references.

The program application attempts to locate all AID file-sets associated with the selected MAD file-set within the selected directory and all its sub-directories. Starting with the selected directory, all its sub-directory structure will be recursively scanned and searched for the associated AID file-sets. If an AID file-set is found, it means that the directory has been indexed before for the designated category, and thus can be searched for possible match. If no AID file-set for the designated category is found, then that directory is deemed as not indexed for the designated category and no search will be performed.

When an AID file-set is found, it will be read in and every of its AIDD_IDXtoken's BIT token will be tested. If the user defined an “OR” boolean search, then if either of the 2 saved bit position values, that is bit position 9 or bit position 14 of the BIT token, is a ‘1’ state, it is deemed a match immediately. If the user defined an “AND” boolean search, then both bit position 9 and bit position 14 of the BIT token must be a ‘1’ state to be deemed a match. When a match is found, the corresponding AIDD_FileName with its pathname is written to a temporary file (or save into a memory array). Once all BIT tokens have been compared, and all directories and its sub-directories have been recursively searched, the full list of matched files is retrieved from the temporary file (or memory array) and presented back to the user for further action. The user can then choose to view a particular document, or delete, move or copy to another directory, or to re-index their attributes, etc.

For the case where “Sequential Identifier Referencing” [“SIR”] indexing method is implemented, comparison of the two saved MADD_PosSeqNbr values of the selected search attributes with the value in each AIDD_PosSeqNbr field within AIDD_IDXtoken for all searched AID-DS files will determine a match outcome. A matched comparison of any of the two saved bit position values is a match for an “OR” boolean search. A matched comparison of both of the two saved bit position values is considered a match for an “AND” boolean search.

There is one special scenario that may need special handling as program application searches and processes AID file-sets in various directories and sub-directories. It happens when the selected MAD file-set has more number of bit positions assigned than that available in the current indexed target file's AIDD_IDXtoken 514 token, that is, the value in MADH_MaxAttrCnt 512 is greater than in the current AIDD_MaxAttrCnt 513 entry. This means that there has been addition of new attributes to the MAD file-set after the current target file has been indexed. Now, the user has selected one or more of these new attributes as search attribute(s). This case may thus require ‘special’ handling, as the new search attribute(s) is not captured in the ‘old’ AIDD_IDXtoken 514 BIT token. In such cases, configuration parameters can be provided for the user to preset beforehand to enable the program application to take the necessary actions (automatically) during the search operation. For example, the possible automated can be YES, MAYBE, NO or PROMPT in response to the question—Is it a match if all search attributes are found in the target file except for ‘new’ attributes that have not been captured in the current searched AID file-set entries? YES means to consider it as a match. MAYBE means to consider it as partial match—still extract the information but display it later in a different color to highlight the partial condition. NO means to consider it as not a match. PROMPT means to prompt the user when such situation occurred to manually (visually and intelligently) determine whether it is a YES or a NO. Most prior art are not able to handling this special scenario.

For the case where “Sequential Identifier Referencing” indexing method is implemented, this special scenario occurs when any of the saved bit position values (in actual fact, the MADD_PosSeqNbr) of the selected search attributes is greater than in the AIDD_MaxAttrCnt entry within the AID-DS detail entries of the searched AID-DS file.

3000—File Management Operation

One other important aspect of this invention is that an AIDD_IDXtoken entry contains all the defined attributes state for an indexed target file. As long as this AIDD_IDXtoken entry is “tagged” along with the indexed target file, whether the target file is copied or moved to another directory or drive or computer, there is no necessity to re-index that target file. All that is needed is to insert the involved AIDD_IDXtoken entry into its target AID file-set.

The selection of indexed target files to copy or to move (example, using multi-line selection facility of the file-listbox) can be performed by dragging the selection to and releasing it over the target directory in the Drives-Directories-Folders tree-view listbox. (This drag-and-drop operation will not be elaborated here as it have been implemented in many windows-based programs, and can be programmed by anyone of reasonable skill in windows programming art.) Knowing the name of the file(s) selected would enable the program application to retrieve its AIDD_IDXtoken entry record(s) from its source AID file-set for re-insertion into the target AID file-set in the target directory. The AIDD_IDXtoken entry record(s) should be removed from its source AID file-set if it is a ‘move’ operation.

This capability can be utilized to give this invention the flexibility of allowing distributed or decentralized indexing. For example, a depository of 1,000,000 images can be split into batches of 10,000 images and sent out to different parts of the world to be indexed by 100 different persons or indexers. Each indexer could be using his own local copy of the MAD file-set translated to his native language (and could even be “sub-view'ed” for whatever the reasons). Once indexing is completed by all the indexers, which can be performed in batches, their image files and their AID file-sets can be merged or re-located to different target destination as long as the AIDD_IDXtoken entry records go along with its respective target indexed image files. Again, this is a feature not commonly found in the prior art, where it needs index entries to be portable.

Automatic Indexing

While the above processes and operations described in the above embodiments involve human intelligence and involvement to conduct visual inspection, define new attributes and to index target files, it is equally possible to use artificial intelligent processes (or other equivalent development) to automate these processes. There are ongoing projects and researches to automate the process of features recognition of images and the like, and in some cases, can thus generate keywords for indexing and classification. Others introduce linguistic and sentence structure analysis to determine the key content of textual files. These generated keywords could be assembled into the MAD data structure, and the appropriate values assigned and set into AIDD_IDXtoken entry automatically in the AID file-set for the target file. Another example, for the case of full text indexing, is to use the top 200 or 300 most commonly used indexed words to build the MAD data structure, and for each indexed text file, to build its AID data structure automatically.

Advantages of this Invention Over the Prior Art

With the 2 data structures synchronized and its linkages maintained, many of the mentioned problems of prior art are removed. This new invention also introduces many new advantages and capabilities that are not easily implemented or possible with prior art. They are summarized as below.

a) The definition of new attribute is performed once and once only in real-time without the need for any pre-processing. The definition is saved in one central MAD file.

b) A full list of defined attributes is readily available for display to the user to select for use during indexing and searching, thus eliminating the problems of recalls (i.e. which keywords have been used before), or what exact keywords are available thus ensuring consistent usage of keywords. It effectively removes other problems associated with the usage of synonyms, abbreviations, singular-plural nouns and tenses—what you see is what you can use, without the need to introduce new term of similar meaning.

c) The selection of attributes to use for indexing and searching is a mere click with a pointing device (e.g. a mouse) on the displayed list of attributes. It does not require the user to type in the same keyword for the same attribute again and again, thus speeding up the indexing process and eliminates typographical errors.

d) The description of the attributes or keywords can be modified and attributes or keywords can be deleted anytime in real-time, without the need to execute any ‘re-indexing’ or ‘re-organizing’ process and without any impact to any previously indexed files.

e) Once an attribute is defined, it can be translated and displayed (as in item(b) above) for indexing and searching in any languages, different from that used in the indexed documents or in defining the keywords. For example, the initial definition of one attribute “dog” was done in Boston using English. Subsequent indexing can be carried out in Canada using a French MAD file for it's indexing front-end display (the attribute is now displayed as “chien”). The searching can be done in Germany using German's front-end display (e.g. as “hund”, instead of “chien” or “dog”). This feature is very suitable for non-textual files, and is equally applicable for textual files as well (except the target file is still in its original language, unless translated copies are available). This is not very practical for current methods and techniques of indexing and searching available today. For the business arena, suppliers and distributors can now distribute CD-ROMs of their catalogs defined and indexed in their own language, but have translated attribute descriptions for the front-ends in the languages of the retailers around the world to search and retrieve information out of the catalogs.

f) The ability to limit “views” by providing sub-views, that is, by displaying only certain keywords for selection as indexing attributes or as search criteria (thereby restricting the retrieval of certain indexed files only through available keywords) can be implemented easily.

g) Indexed files can be copied or moved to another directory, drive or computer, without the need to do any ‘re-indexing’ by the user on the impacted files. This provides an additional capability that allows indexing to be performed in a distributed or de-centralized manner and be merged into a centralized pool later without the need to do any ‘re-indexing’.

h) Additional properties can be assigned to each defined attribute, as each defined attribute are uniquely identifiable, such as location position for multiple screen and report layouts, expanded description for the keyword, etc. into the MAD detail set for use by the program application.

i) Program application is able to detect changes, that is, new attributes added to the MAD-DS file since a current indexed target file last indexed.

While there have been shown, described and pointed out fundamental novel features of the invention as applied to embodiments thereof, it is understood that various omissions, substitutions and changes to the structures and process steps, and in the form and details of the invention, as herein disclosed, may be made by those skilled in the art without departing from the spirit of the invention. It is expressly intended that all combinations of those elements, method or steps which perform substantially the same function in substantially the same way to achieve the same results are within the scope of the invention. It is the intention, therefore, to be limited only as indicated by the scope of the claims appended hereto.

1. A system for the indexing of computer files or records, comprising:
a data storage device capable of storing a plurality of computer files or records wherein each computer file or record is identifiable by one or more attributes;
a first collection of information including a series of attributes of the computer files or records by which said computer files or records are identifiable; and a second collection of information including entries for each computer file or record that is being indexed;
characterized in that the system comprises linking means for linking the entries in the second collection of information with specific attributes in the first collection of information to identify the presence or absence of an attribute in each computer file or record being indexed.

2. The system of claim 1, wherein the first collection of information comprises of one or more detail sets of data identifiers, and each detail set maintaining information for each attribute of a predetermined category of computer files or records.

3. The system of claim 2, wherein the number of defined attributes in the first collection is contained in a respective header set of data identifiers.

4. The system of claim 1, wherein the second collection of information comprises one or more sets of data identifiers, each set maintaining information for one indexed computer file or record of a predetermined category of computer files or records.

5. The system of claim 2, wherein the second collection of information includes summary data identifiers wherein comparison of the header set of data identifiers in the first collection with summary data identifiers in the second collection identifies new attributes defined since the second collection of information was last updated.

6. The system of claim 1, wherein the linking means comprises location pointers associated with an identifiable segment of a string of separately identifiable segments of information in the second collection of information and each segment of information represents the presence or absence of an attribute in a computer file being indexed to point to each attribute in the first collection of information.

7. The system of claim 6, wherein each separately identifiable segment of information in the second record set is a data value such that pre-determined data values represent the presence or absence of an attribute for a computer file or record.

8. The system of claim 6, wherein each separately identifiable segment of information in the second collection of information consists of one or more bits of data in a binary string.

9. The system of claim 1, which includes input means for a user to select attributes of each computer file or record into the system for the purpose of indexing.

10. The system of claim 1, which includes input means for the user to define and/or modify any of the attributes in the first collection such that new definitions and modifications are immediately available and do not affect the links created for any previously indexed computer files or records.

11. The system of claim 1, which includes interface means for a computer program to recognize attributes for a computer file to be indexed and present said attributes to said system for indexing.

12. The system of claim 1, wherein the first collection of information, second collection of information and plurality of computer files or records are separable from the data storage device and each be stored separately on different data storage device.

13. The system of claim 1, wherein either or both of the first collection of information and second collection of information are manifested in a form selected from the group consisting of database tables, database rows, entries within the registry of an operating system, index entries in index structures and in flat files.

14. The system of claim 1, which includes a collection of data identifiers storing attributes that duplicate attributes contained in the first collection of information in a language different from that provided in the first collection such that attributes information can be viewed and used in another language.

15. The system of claim 1, wherein a selection from the first collection of information can be duplicated for selected usage.

16. The system of claim 1, which include creating one or more copies of the first collection of information, each said copy containing additional attributes thereby allowing additional attributes information to be defined, captured and used.

17. The system of claim 1, wherein the second collection of information is separable into a series of groups, each group representing a collection of indexed computer files or records.

18. The system of claim 1, wherein when an indexed computer file or record is copied or moved from its source location to a target location, the set of data identifiers in the second collection on the source location for the indexed computer file or record is copied or moved into a second collection on said target location such that it eliminates the need to re-index said computer file on said target location.

19. A method of indexing a collection of computer files or records in a data storage device, each computer file or record being identifiable by one or more attributes, comprising the steps of:
maintaining a first collection of information including a series of attributes of the computer files or records by which said computer files or records are identifiable and a second collection of information including entries for each computer file or record that is being indexed;
providing linking means for linking the entries in the second collection of information with specific attributes in the first collection of information to identify the presence or absence of an attribute in each computer file being indexed.

20. The method of claim 19, wherein the first collection of information comprises of one or more detail sets of data identifiers, and each detail set maintaining information for each attribute of a predetermined category of computer files or records.

21. The method of claim 20, wherein the last assigned Identifier-ID, and optionally the number of defined attributes, in the first collection is contained in a respective header set of data identifiers.

22. The method of claim 19, wherein the second collection of information comprises one or more sets of data identifiers, each set maintaining information for one indexed computer file or record of a predetermined category of computer files or records.

23. The method of claim 19, wherein the second collection of information includes summary data identifiers wherein comparison of the header set of data identifiers in the first collection with the summary data identifiers in the second collection identifies new attributes defined since the second collection of information was last updated.

24. The method of claim 19, wherein the linking means comprises location pointers associated with an identifiable segment of a string of separately identifiable segments of information in the second collection of information and each segment of information represents the presence or absence of an attribute in a computer file being indexed to point to each attribute in the first collection of information.

25. The method of claim 24, wherein each separately identifiable segment of information in the second collection is a data value such that pre-determined data values represent the presence or absence of an attribute for a computer file or record.

26. The method of claim 24, wherein each separately identifiable segment of information in the second collection of information consists of one or more bits of data in a binary string.

27. The method of claim 19, which includes input means for a user to select attributes of each computer file or record into the system for the purpose of indexing.

28. The method of claim 19, which includes input means for the user to define and/or modify any of the attributes in the first collection such that new definitions and modifications are immediately available and do not affect the links created for any previously indexed computer files or records.

29. The method of claim 19, which includes interface means for a computer program to recognize attributes for a computer file to be indexed and provide said attributes to said system for indexing.

30. The method of claim 19, wherein the first collection of information, second collection of information and plurality of computer files or records are separable from the data storage device and each be stored separately on different data storage device.

31. The method of 19, wherein either or both of the first collection of information and second collection of information are manifested in a form selected from the group consisting of database tables, database rows, entries within the registry of an operating system, index entries in index structures and in flat files.

32. The method of claim 19, which includes a collection of data identifiers storing attributes that duplicate attributes contained in the first collection of information in a language different from that provided in the first collection such that attributes information can be viewed and used in another language.

33. The method of claim 19, wherein a selection from the first collection of information can be duplicated for selected usage.

34. The method of claim 19, further comprising the step of creating one or more copies of the first collection of information, each said copy containing additional attributes thereby allowing additional attributes information to be defined, captured and used.

35. The method of claim 19, wherein the second collection of information is separable into a series of groups, each group representing a collection of indexed computer files or records.

36. The method of claim 19, wherein when an indexed computer file or record is copied or moved from its source location to a target location the set of data identifiers in the second collection on the source location for the indexed computer file or record is copied or moved into a second collection on said target location such that it eliminates the need to re-index said computer file on said target location.

37. A method of indexing a collection of computer files or records in a data storage device, each computer file or record being identifiable by one or more attributes, comprising the steps of:
maintaining a first collection of information and a second collection of information;
providing an input means for a user to define, select and/or modify the description of attributes of the computer files or records into the first collection of information;
providing display means for the description of attributes in the first collection by which the computer files or records are identifiable such that users can view and select for use all defined attributes;
providing linking means to link segments of information in the second collection of information, each segment of information defining the presence or absence of a defined attribute to the attributes of the first collection of information;
wherein the second collection of information includes location pointers pointing to the location of the computer file or record.
